(19) United States
(12) Patent Application Publication
(10) Pub. No.: US 2023/0409379 A1
(43) Pub. Date: Dec. 21, 2023

(54) INFORMATION PROCESSING DEVICE AND JOB SCHEDULING METHOD

(71) Applicant: Fujitsu Limited, Kawasaki-shi (JP)

(72) Inventor: Yosuke OYAMA, Kawasaki (JP)

(73) Assignee: Fujitsu Limited, Kawasaki-shi (JP)

(21) Appl. No.: 18/117,092

(22) Filed: Mar. 3, 2023

(30) Foreign Application Priority Data
Jun. 15, 2022 (JP) 2022-096910

(51) Int. Cl. G06F 9/48

(52) U.S. Cl. CPC G06F 9/4843; G06F 2209/486

(57) ABSTRACT

A non-transitory computer-readable recording medium stores a program for causing a computer to execute a process that includes when a job is executed by nodes in a system, receiving designation of a number of nodes to be used by an application of the job, abnormality occurrence probability of the nodes in the system, a ratio of processing time of an abnormal node to processing time of a normal node, and benchmark time for executing a benchmark; creating a performance model that outputs an expected value of resource consumption amount for executing the job, from an expected value of execution time for executing the job, the number of nodes to be used, and a first number of spare nodes for the job, based on the designation; and determining a second number of the spare nodes that minimizes the expected value of the resource consumption amount using the performance model.

### CROSS-REFERENCE TO RELATED APPLICATION

This application is based upon and claims the benefit of priority of the prior Japanese Patent Application No. 2022-96910, filed on Jun. 15, 2022, the entire contents of which are incorporated herein by reference.

### FIELD

The embodiment discussed herein is related to an information processing device and a job scheduling method.

### BACKGROUND

Traditionally, there is a cluster-type supercomputer including many high-performance computers. In the cluster-type supercomputer, for example, a job scheduler allocates a computation job submitted by a user to a free node to perform application computation. Supercomputers are used, for example, for large-scale and advanced scientific and technical computation such as weather prediction, space development, and genetic analysis.

Related art includes a technique for dynamically adjusting the tasks of performance management and application placement management. In addition, there is a technique using processor units that have been checked to operate normally as a result of an operation test on each processor unit, in which a data processing program is distributed to each processor unit and divided pieces of data are allocated to each processor unit.

In addition, there is a technique that sequentially substitutes performance specification information into a quantitative model to calculate the throughput for each pool server and selects a pool server corresponding to the throughput that is greater than the amount of change in throughput but indicates the closest value, to instruct the selected pool server to execute configuration change control. There is also a technique that predicts the possibility of fault of nodes that execute an application in parallel and shifts a computing node whose possibility of fault exceeds a threshold value to a spare computing node at the next scheduled checkpoint. There is also a technique for job management in a high performance computing (HPC) environment.

Japanese National Publication of International Patent Application No. 2008-515106, Japanese Laid-open Patent Publication No. 10-162130, International Publication Pamphlet No. WO 2007/034826, U.S. Patent Application Publication No. 2010/0223379, U.S. Patent Application Publication No. 2020/0004648, and U.S. Patent Application Publication No. 2018/0121253 are disclosed as related art.

### SUMMARY

According to an aspect of the embodiment, a non-transitory computer-readable recording medium stores a program for causing a computer to execute a process, the process includes when a job is executed by one or more nodes in a system, receiving designation of a number of nodes to be used by an application related to execution of the job, abnormality occurrence probability of the one or more nodes in the system, a ratio of processing time of an abnormal node to processing time of a normal node in the system, and benchmark time involved in executing a benchmark that is executed in the job prior to the application; creating a performance model that outputs an expected value of resource consumption amount involved in executing the job, from an expected value of execution time involved in executing the job, the number of nodes to be used, and a first number of spare nodes for the job, based on the received designation; and determining a second number of the spare nodes that minimizes the expected value of the resource consumption amount using the created performance model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a job scheduling method according to an embodiment;

FIG. 2 is a diagram illustrating a system configuration example of a job scheduling system;

FIG. 3 is a diagram illustrating an example of a network topology;

FIG. 4 is a diagram illustrating a hardware configuration example of a login node and the like;

FIG. 5 is a diagram illustrating a functional configuration example of the login node;

FIG. 6 is a diagram illustrating an example of calculation of E[C];

FIG. 7 is a diagram illustrating a functional configuration example of a node Ni;

FIG. 8 is a diagram illustrating an example of the stored contents of a benchmark execution time table;

FIG. 9 is a diagram illustrating an operation example of the job scheduling system;

FIG. 10 is a diagram illustrating an example of coupling between nodes;

FIG. 11 is a diagram illustrating a job execution example;

FIG. 12 is a flowchart (part 1) illustrating an example of a job submission processing procedure of the login node;

FIG. 13 is a flowchart (part 2) illustrating the example of the job submission processing procedure of the login node;

FIG. 14 is a flowchart illustrating an example of a specific processing procedure of an EC calculation process;

FIG. 15 is a flowchart illustrating an example of a job execution control processing procedure of the node Ni;

FIG. 16A is a diagram (part 1) illustrating a specific example of benchmark time of each node;

FIG. 16B is a diagram (part 2) illustrating a specific example of benchmark time of each node; and

FIG. 17 is a diagram illustrating an example of prediction of E[C].

### DESCRIPTION OF EMBODIMENT

In the related techniques, when such an abnormality that is difficult to detect at the system side occurs in a node in the supercomputer, the abnormal node will be allocated to the job and the computational performance for the application will be degraded in some cases. For example, although it is conceivable to suppress the degradation of the computational performance by submitting a job with a redundant number of nodes, if the number of nodes is too large, there is a problem that the degradation of the utilization efficiency and an increase in the utilization fee of the supercomputer may be brought about. In addition, if the number of nodes is too small, there is still a problem that the computational performance may be degraded.

An embodiment of an information processing device and a job scheduling method will be described in detail below with reference to the drawings.

### Embodiment

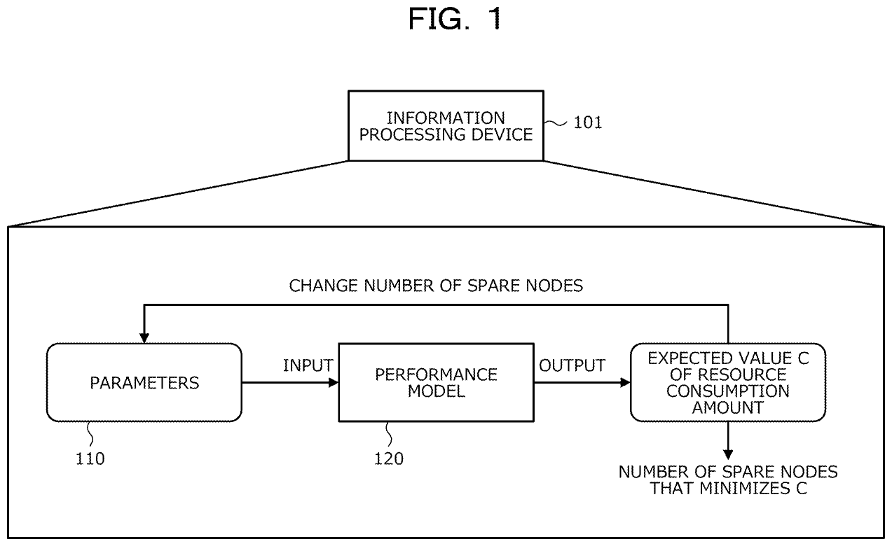

FIG. 1 is a diagram illustrating an example of the job scheduling method according to an embodiment. In FIG. 1, an information processing device 101 is a computer that determines the number of spare nodes when one or more nodes in a system execute jobs. The system includes a plurality of nodes that may communicate with each other. The system is, for example, a cluster-type supercomputer.

Each node is a computer that has a communication function and may execute various processes. The node may be, for example, a physical server or a virtual machine. The job is a unit of processing work for the computers and, for example, is a unit of computation designated by a user. The process executed within the job is, for example, a user-dependent process.

For example, the process executed within the job is often computed in cooperation with all nodes by a program (application) parallelized by message passing interface (MPI) or the like. In the parallelized program, computation for each node and communication between nodes are performed.

For example, in deep learning, collective communication (parameter synchronization) and computation for each node (forward and backward computation) are alternately performed. In addition, in fluid analysis, collective communication/peer-to-peer (P2P) communication (inner product/sparse matrix vector product of the conjugate gradient (CG) method) and computation for each node are performed alternately.

The spare nodes are nodes that are extra prepared for executing a job. The number of spare nodes is the number of redundant nodes when a greater number of nodes than the number of nodes used for the application related to the execution of the job are prepared.

A job scheduler is software that schedules units of computation (jobs) designated by the user and allocates the scheduled units of computation to nodes of a supercomputer or the like. Each job has information on, for example, the computation contents, the number of nodes to be used, and the maximum usage time (wall-time). Usually, the user is not allowed to select and use particular nodes.

In an average job scheduler, for example, a job submitted into a queue first is executed first. For example, it is assumed that each of jobs A, B, and C are submitted into a queue in the order of “job A job B job C”. In addition, the total number of nodes of the supercomputer is assumed to be “eight nodes”. It is also assumed that the number of nodes to be used by the job A is “3”, the number of nodes to be used by the job B is “4”, and the number of nodes to be used by the job C is “4”.

In this case, since the job A is submitted into the queue before the job C, the job A is prioritized over the job C even if idle nodes are occurred. For example, among nodes node_1 to node_8, if node_1 to node_3 are allocated to the job A and node_4 to node_7 are allocated to the job B, node_8 is treated as an idle node. Note that the numbers “1” to “8” in “node_1” to “node_8” correspond to node identifiers (IDs).

As a result, nodes with discontinuous node IDs are allocated to a job in some cases. For example, when the execution of the job A is completed while the job B is being executed and the job C becomes executable, the job C is allocated to node_1 to node_3 and node_8. Node_1 to node_3 and node_8 are nodes with discontinuous node IDs.

In addition, the nodes allocated to each job are released immediately, for example, when the job computation ends or the wall-time is exceeded. For example, if the computation of the job A is completed in 45 minutes when the wall-time of the job A is assumed to be “one hour”, node_1 to node_3 allocated to the job A will be released and allocated to the next job without waiting for the passage of wall-time (one hour). In addition, even if the computation of the job C is not completed in one hour when the wall-time of the job C is assumed to be “one hour”, node_1 to node_3 and node_8 allocated to the job C will be released when the wall-time (one hour) is exceeded.

In addition, in an average job scheduler, idle nodes are permitted to overtake in the queue in some cases by a mechanism called backfill. For example, it is assumed that a job D is submitted after the job C. The number of nodes to be used by the job D is assumed to be “1”. In this case, among node_1 to node_8, node_1 to node_3 are allocated to the job A, node_4 to node_7 are allocated to the job B, and additionally, node_8 is allocated to the job D submitted after the job C. The backfill may lessen the idle nodes and improve the entire utilization efficiency of the supercomputer.

Here, hardware abnormalities and process (software) abnormalities sometimes occur in the nodes of the supercomputer. When such abnormalities are not fully detected at the system side, an abnormal node is allocated to the user and the computational performance for the application is degraded in some cases. For example, if a job is allocated to a group of nodes including an abnormal node, the computational performance will be degraded due to the rate limitation caused by the abnormal node, which in turn leads to the degradation of the utilization efficiency of the supercomputer and an increase in the utilization fee for the user.

Abnormalities that may be a main cause of the degradation of application performance include abnormalities that occur due to the effects of jobs previously executed on the node. For example, a process or local file generated by a preceding job is sometimes not deleted or not initialized by the system, resulting in the occurrence of an abnormality. In addition, even if settings that affect the performance (such as the clock frequency as an example) have been altered in the preceding job, these settings are sometimes not restored by the system, resulting in the occurrence of an abnormality.

There are also abnormalities that occur due to abnormalities or bugs in processes and daemons operating at the operating system (OS) level. In addition, there are abnormalities that occur due to individual differences in hardware, such as differences in used clock frequencies caused by variations in power consumption characteristics of processors.

There are also cases where the network (interconnect) between nodes is shared with another job and waiting time occurs due to the communication for the another job. In addition, in a supercomputer having a function of logically sharing a single node with a plurality of jobs, hardware such as processors and memories compete with other jobs in some cases.

Such abnormalities are often discovered only after the user submits a job and checks the result, but it is difficult to identify the cause at the user side. For example, the execution time of the application is sometimes not known prior to execution, making it wholly difficult to confirm whether a particular node is responsible for the cause of performance degradation.

In addition, when the wall-time is exceeded and the application is forcibly terminated, if the application is forcibly terminated before the log for checking the processing result is output, it is difficult to identify the cause of performance degradation at the user side. It is also difficult to find a solution through consultation between the user and the manager side because the manager side is often not concerned with the applications executed by the user.

In addition, due to the nature of the problem, there is a high possibility that performance degradation will arise in jobs that use many nodes, and accordingly, the work for narrowing down to the node that is the cause from among these nodes will occur. However, the work of narrowing down the nodes involves a lot of time and load. In addition, in an average job scheduler, designating a particular node to submit a job at the user side is not allowed. For this reason, it is not feasible to perform validation at the user side by strictly fixing the node deemed to be the cause.

In addition, in an average job scheduler, for example, in a case where a job is to be resubmitted when the wall-time is exceeded or manually resubmitted when an abnormality is discovered, by the mechanism of backfill, there is a possibility that the abnormal node that is the cause will be allocated again. For this reason, resubmitting the job is not a method for solving the problem.

Therefore, it is conceivable to suppress the degradation of computational performance by first submitting a job with a redundant number of nodes and then performing application computation after excluding nodes with slow processing from among these nodes. However, if the number of nodes is too large, there is a problem that the degradation of the utilization efficiency and an increase in the utilization fee may be brought about. On the other hand, if the number of nodes is too small, there is still the problem that the computational performance may be degraded.

Thus, in the present embodiment, a job scheduling method for determining the number of nodes to efficiently execute a job when submitting a job with a redundant number of nodes in consideration of the occurrence of an abnormal node will be described. Here, a processing example of the information processing device 101 (corresponding to the processes (1) to (3) below) will be described.

(1) The information processing device 101 receives designation of parameters 110 when one or more nodes in the system execute a job. The parameters 110 are designated by, for example, a user who is to submit the job. The parameters 110 include the number of nodes to be used by the application related to the execution of the job. The number of nodes to be used has a value equal to or greater than one and is determined, for example, in consideration of the properties of the application, the computation speed, and the like.

The parameters 110 also include abnormality occurrence probability of the nodes in the system. The abnormality occurrence probability has a value common to all nodes in the system and the value is equal to or greater than zero but equal to or smaller than one. The system is, for example, a supercomputer including a plurality of nodes (high-performance computers). The parameters 110 also include the ratio of the processing time of an abnormal node to the processing time of a normal node in the system.

The abnormal node is a node in which an abnormality that may be a main cause of degradation of application performance has occurred. The normal node is a non-abnormal node other than the abnormal node. The processing time is, for example, the processing time involved in computation for the application or the processing time involved in executing a benchmark. The ratio of the processing time has, for example, a value greater than one represented by the rate of increase in the processing time of the abnormal node to the processing time of the normal node.

The parameters 110 also include benchmark time involved in executing the benchmark. The benchmark is software for evaluating the performance of the node, which is executed prior to the application within the job. The benchmark is executed to confirm which node to be excluded from the group of nodes allocated to the job with a redundant number of nodes.

In addition, the parameters 110 may include, for example, first processing time that is affected by performance degradation due to the abnormal node and second processing time that is not affected by the performance degradation due to the abnormal node, within the execution time of the application. The first processing time is, for example, the computation time involved in computation of each node in the application. The second processing time is, for example, the communication time involved in communication between nodes in the application.

The first processing time and the second processing time may have values designated at the system side. For example, the information processing device 101 may assume the first processing time to be a value defined from the wall-time or the like of the job and assume the second processing time to be a fixed value (such as zero).

(2) The information processing device 101 creates a performance model 120 based on the received designation of the parameters 110. The performance model 120 is a model that outputs the expected value of the resource consumption amount involved in executing the job, from the expected value of execution time involved in executing the job, the number of nodes to be used, and the number of spare nodes for the job.

The resource consumption amount represents the amount of system resources consumed when a job is submitted with a redundant number of nodes. The resource consumption amount corresponds to the cost in consideration of the increase in the number of nodes during job execution and the usage time of the nodes due to the spare nodes and the benchmark.

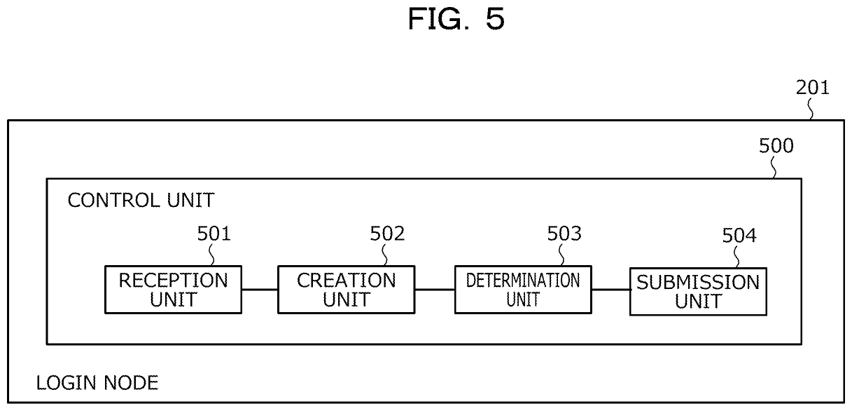

For example, the information processing device 101 creates the performance model 120 from predetermined model formulas (for example, a first model formula, a second model formula, a third model formula, a fourth model formula, and a fifth model formula, which will be described later) based on the received designation of the parameters 110. A specific example of the process for creating the performance model 120 will be described later with reference to FIG. 5.

(3) The information processing device 101 uses the created performance model 120 to determine the number of spare nodes that minimizes the expected value of the resource consumption amount involved in executing the job. For example, the information processing device 101 uses the performance model 120 to calculate an expected value C of the resource consumption amount while changing the number of spare nodes in order from zero to the number of nodes to be used by the application.

Then, the information processing device 101 may determine the number of spare nodes corresponding to the minimum value among the calculated expected values C of the resource consumption amount, as the number of spare nodes that minimizes the expected value of the resource consumption amount. The determined number of spare nodes is used as the number of redundant nodes when submitting the job with a redundant number of nodes.

In this manner, according to the information processing device 101, when submitting a job with a redundant number of nodes in consideration of the occurrence of an abnormal node, the number of spare nodes that minimizes the expected value C of the resource consumption amount involved in executing the job may be located by search, and the number of nodes to efficiently execute the job may be determined. This allows the information processing device 101 to submit a job by designating the number of spare nodes that minimizes the expected value of the resource consumption amount involved in executing the job.

(System Configuration Example of Job Scheduling System)

Next, a system configuration example of a job scheduling system including the information processing device 101 illustrated in FIG. 1 will be described. Here, a case where the information processing device 101 illustrated in FIG. 1 is applied to a login node in the job scheduling system will be described as an example. The job scheduling system is applied, for example, to a supercomputer for executing jobs such as fluid analysis, structural analysis, and electromagnetic field analysis.

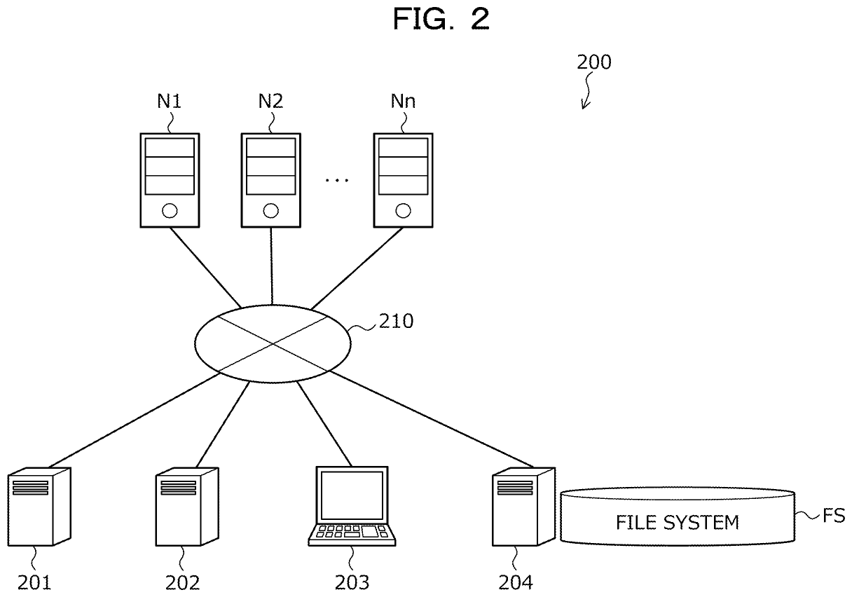

FIG. 2 is a diagram illustrating a system configuration example of a job scheduling system 200. In FIG. 2, the job scheduling system 200 includes a login node 201, a management node 202, a client terminal 203, a storage server 204, and computing nodes N1 to Nn (n: a natural number equal to or greater than two). In the job scheduling system 200, the login node 201, the management node 202, the client terminal 203, the storage server 204, and the computing nodes N1 to Nn are coupled via a wired or wireless network 210. For example, the network 210 is the Internet, a local area network (LAN), a wide area network (WAN), or the like.

In the following description, an arbitrary computing node among the computing nodes N1 to Nn will be sometimes referred to as a “computing node Ni” (i=1, 2, . . . , n). In addition, the computing node will be sometimes simply referred to as a “node”.

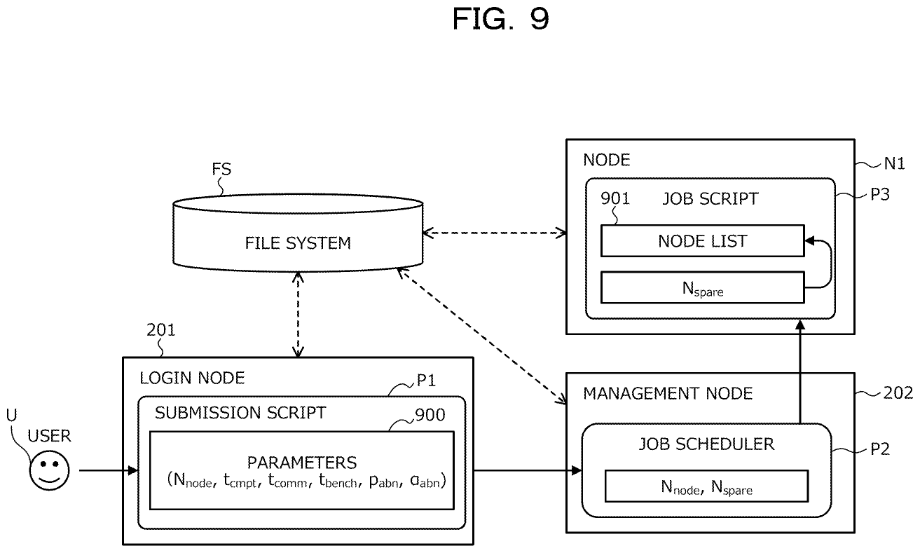

Here, the login node 201 is a computer that may be directly operated by a user. The login node 201 executes, for example, a submission script P1 as illustrated in FIG. 9, which will be described later. The submission script P1 is an information processing program for submitting a job. The login node 201 is, for example, a server.

The management node 202 is a computer for administering the job scheduling system 200. The management node 202 executes, for example, a job scheduler P2 as illustrated in FIG. 9, which will be described later. The job scheduler P2 is a program for job scheduling. The management node 202 is, for example, a server.

The client terminal 203 is a computer used by a user of the job scheduling system 200. For example, the user performs job submission and the like by operating the login node 201 from the client terminal 203. For example, the client terminal 203 is a personal computer (PC), a tablet PC, or the like.

The storage server 204 is a computer that has a file system FS and stores the main bodies (executable files) of various programs executed by the various nodes 201, 202, and N1 to Nn and data. The various nodes 201, 202, and N1 to Nn, for example, access the file system FS of the storage server 204 to acquire information on various programs.

The computing nodes N1 to Nn are computers to which jobs are allocated. A job script P3 as illustrated in FIG. 9, which will be described later, is executed in any one node Ni in the group of nodes to which the job is allocated. The job script P3 is an information processing program for executing an application related to the execution of the job. Each of the computing nodes N1 to Nn is, for example, a server.

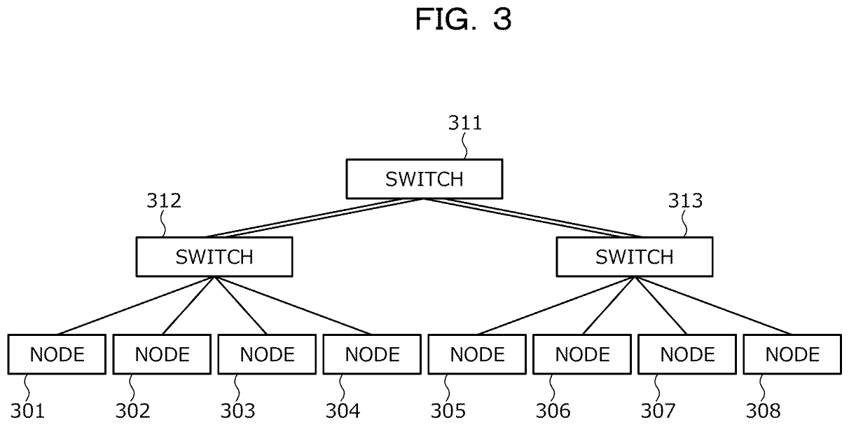

In the job scheduling system 200, for example, communication between the computing nodes and communication between the login node 201, the management node 202, and the storage server 204 are enabled through interconnect having a network topology (communication architecture) as illustrated in FIG. 3. As a specific example of the interconnect in the job scheduling system 200, for example, a fat tree network may be mentioned.

Note that the login node 201, the management node 202, and the computing nodes Ni are assumed here to be separately provided, but are not limited to this. For example, the login node 201, the management node 202, and the computing nodes Ni may be implemented by one computer. In addition, the login node 201 may be implemented by the management node 202. In addition, the management node 202 may be implemented by the computing node Ni. Furthermore, the submission script P1 may be implemented as one function of the job scheduler P2, for example. In addition, the job script P3 may be implemented as one function of the job scheduler P2, for example.

(Network Topology)

Here, the network topology of the interconnect within the job scheduling system 200 will be described with reference to FIG. 3.

FIG. 3 is a diagram illustrating an example of the network topology. In FIG. 3, nodes 301 to 308 are examples of the computing nodes N1 to Nn illustrated in FIG. 2. The nodes 301 to 308 are coupled via switches 311 to 313 (network devices). Here, the routes on an upstream side of the tree-like network structure are made redundant. This allows the nodes 301 to 308 to perform high-performance communication even between nodes in non-consecutive physical locations.

(Hardware Configuration Example of Login Node and the Like)

Next, a hardware configuration example of the login node 201, the management node 202, the storage server 204, and the computing nodes Ni to Nn illustrated in FIG. 2 will be described. Here, the login node 201, the management node 202, the storage server 204, and the computing nodes N1 to Nn will be referred to as the “login node 201 and the like”.

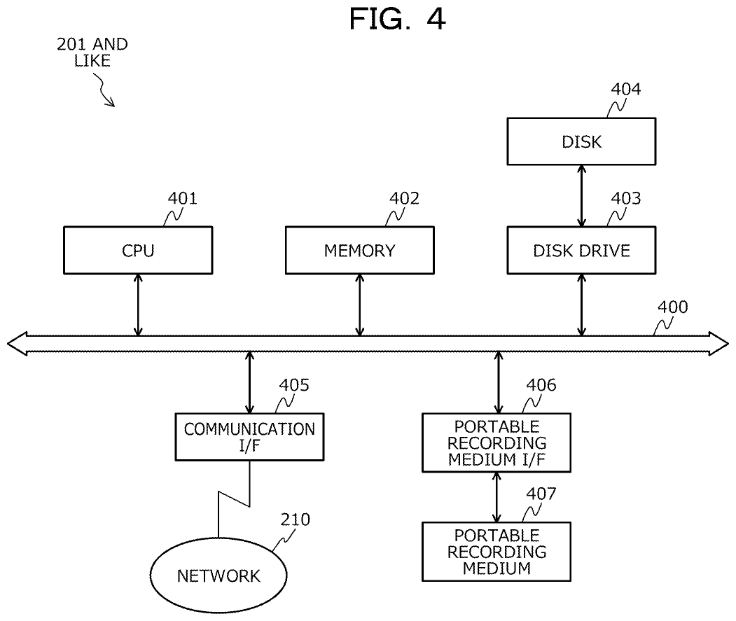

FIG. 4 is a diagram illustrating a hardware configuration example of the login node 201 and the like. In FIG. 4, the login node 201 and the like include a central processing unit (CPU) 401, a memory 402, a disk drive 403, a disk 404, a communication interface (I/F) 405, a portable recording medium I/F 406, and a portable recording medium 407. In addition, the individual components are coupled to each other by a bus 400.

Here, the CPU 401 is in control of the entire login node 201 and the like. The CPU 401 may include a plurality of cores. For example, the memory 402 includes a read only memory (ROM), a random access memory (RAM), a flash ROM, and the like. For example, the flash ROM stores an OS program, the ROM stores application programs, and the RAM is used as a work area for the CPU 401. The programs stored in the memory 402 are loaded into the CPU 401 to cause the CPU 401 to execute coded processes.

The disk drive 403 controls reading/writing of data from/to the disk 404 under the control of the CPU 401. The disk 404 stores data written under the control of the disk drive 403. Examples of the disk 404 include a magnetic disk, an optical disc, and the like.

The communication I/F 405 is coupled to the network 210 through a communication line and is coupled to an external computer via the network 210. Then, the communication I/F 405 supervises the interface between the network 210 and the inside of the device and controls input and output of data from the external computer. For example, a modem, a LAN adapter, or the like may be adopted as the communication I/F 405.

The portable recording medium I/F 406 controls reading/writing of data from/to the portable recording medium 407 under the control of the CPU 401. The portable recording medium 407 stores data written under the control of the portable recording medium I/F 406. Examples of the portable recording medium 407 include a compact disc (CD)-ROM, a digital versatile disk (DVD), a universal serial bus (USB) memory, and the like.

Note that the login node 201 and the like may include, for example, an input device, a display, or the like, in addition to the components described above. In addition, the login node 201 and the like do not have to include, for example, the portable recording medium I/F 406 and the portable recording medium 407 among the components described above. Furthermore, the client terminal 203 illustrated in FIG. 2 may be implemented by a hardware configuration similar to the hardware configuration of the login node 201 and the like. Note that, for example, the client terminal 203 includes an input device, a display, and the like, in addition to the components described above.

(Functional Configuration Example of Login Node)

Next, a functional configuration example of the login node 201 will be described.

FIG. 5 is a diagram illustrating a functional configuration example of the login node 201. In FIG. 5, the login node 201 includes a reception unit 501, a creation unit 502, a determination unit 503, and a submission unit 504. The reception unit 501 to the submission unit 504 have functions to form a control unit 500, and for example, these functions are implemented by causing the CPU 401 to execute a program (the submission script P1 as illustrated in FIG. 9 to be described later) stored in a storage device such as the memory 402, the disk 404, or the portable recording medium 407 of the login node 201 illustrated in FIG. 4, or by the communication I/F 405. The processing result of each functional unit is stored in, for example, a storage device such as the memory 402 or the disk 404 of the login node 201.

The reception unit 501 receives designation of parameters when one or more nodes in the job scheduling system 200 execute a job. The parameters include, for example, N_{node}, p_{abn}, α_{abn}, and t_{bench}. Here, the number of nodes to be used by the application related to the execution of the job is represented by N_{node}. For example, the user determines N_{node} in consideration of the properties of the application, the computation speed, and the like.

In the following description, the application related to the execution of the job will be sometimes simply referred to as an “application”.

The abnormality occurrence probability of a node in the job scheduling system 200 is represented by p_{abn}. A value common to all nodes of the job scheduling system 200 is given to p_{abn} and the value is equal to or greater than zero but equal to or smaller than one. It is supposed that each node is abnormal at p_{abn} and does not change in state during job execution.

A coefficient (abnormal node computation time coefficient) representing the ratio of (rate of increase in) the processing time of the abnormal node to the processing time of the normal node in the job scheduling system 200 is denoted by α_{abn}. A value greater than one is given to α_{abn}. It is supposed that the abnormal node has the computation time (t_{bench}, t_{cmpt}) multiplied by α_{abn} times. For example, the abnormal node has t_{bench} increased by α_{abn} times compared with the normal node.

The benchmark time involved in executing the benchmark is represented by t_{bench}. The benchmark is software for evaluating the performance of the node, and is executed prior to the application within the job. As the benchmark, for example, lightweight software that limits the computation rate, such as UNPACK, is used.

Here, it is supposed that, when the benchmark is executed in all nodes, the abnormal node is positioned highest when the benchmark time is sorted in descending order for all nodes. At this time, if the number of abnormal nodes is equal to or smaller than the number of spare nodes for the job, the abnormal nodes may be excluded from the execution of the application. On the other hand, when the number of abnormal nodes is greater than the number of spare nodes, the abnormal nodes may not be excluded from the execution of the application.

The parameters may also include, for example, t_{cmpt} and t_{comm}. The computation time involved in the computation of each node in the application is denoted by t_{cmpt} (where t_{cmpt}>0). An example of the first processing time that is affected by performance degradation due to the abnormal node, within the execution time of the application, is given by t_{cmpt}.

The communication time involved in communication between nodes in the application is denoted by t_{comm} (where t_{comm}≥0). An example of the second processing time that is not affected by performance degradation due to the abnormal node, within the application execution time, is given by t_{comm}. For example, the user determines t_{cmpt} and t_{comm} in consideration of the properties of the application, the computation speed, and the like.

Note that some applications dominantly have time that does not fall under either of the computation and communication, such as input/output (I/O). In this case, a value may be designated by assuming t_{cmpt} as the first processing time that is affected by performance degradation due to the abnormal node, within the application execution time, and a value may be designated by assuming t_{comm} as the second processing time that is not affected by performance degradation due to the abnormal node.

For example, by accepting a submission request for a job from the client terminal 203 illustrated in FIG. 2, the reception unit 501 may receive designation of parameters included in the submission request for the job. The submission request for the job includes, for example, information such as computation contents and maximum usage time (wall-time) of the job, in addition to the parameters described above.

The creation unit 502 creates a performance model M based on the received designation of the parameters. The performance model M includes a model formula that outputs E[C] from E[Tₜₒₜₐₗ] and Nₜₒₜₐₗ. The expected value of Tₜₒₜₐₗ is represented by E[Tₜₒₜₐₗ]. Job time is represented by Tₜₒₜₐₗ. The job time is the execution time involved in executing the job.

The number of all nodes related to the execution of the job is represented by Nₜₒₜₐₗ. The number obtained by summing up N_{node} and Nₛₚₐᵣₑ is denoted by Nₜₒₜₐₗ (where Nₜₒₜₐₗ is an integer equal to or greater than one but equal to or smaller than the maximum number of nodes). The number of nodes to be used by the application related to the execution of the job is represented by N_{node} (where N_{node} is an integer equal to or greater than one but equal to or smaller than the maximum number of nodes). The number of spare nodes for the job is represented by Nₛₚₐᵣₑ (where Nₛₚₐᵣₑ is an integer equal to or greater than one but equal to or smaller than the maximum number of nodes).

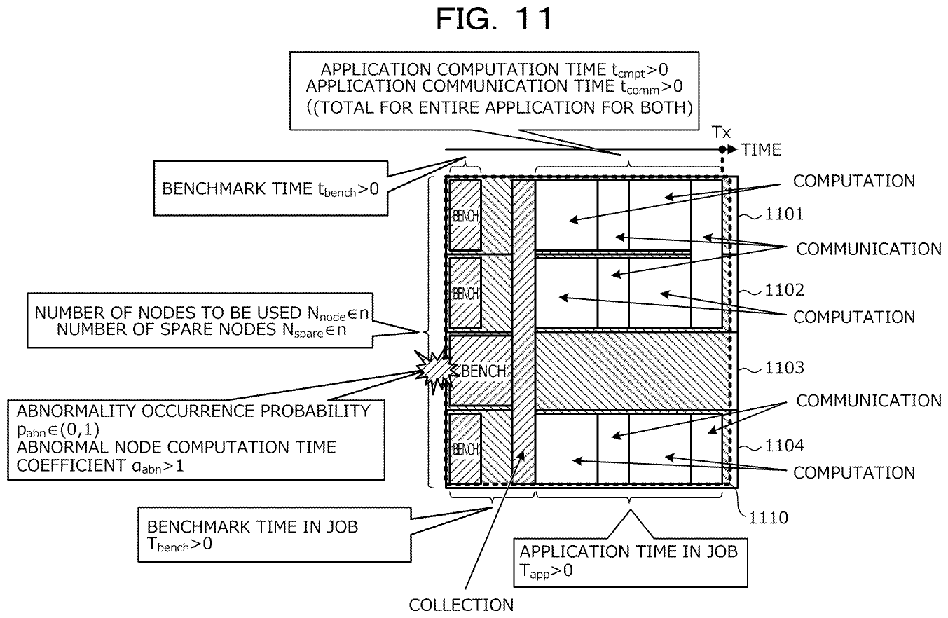

The expected value of node time (cost) is represented by E[C]. The node time is an index representing the resource consumption amount involved in executing the job and, for example, corresponds to a value obtained by multiplying (the number of nodes) and (the usage time of the node) involved in executing the job (corresponding to, for example, the area of the dotted line frame 1110 illustrated in FIG. 11 to be described later). The performance model 120 illustrated in FIG. 1 corresponds to the performance model M, for example.

For example, the creation unit 502 creates a first model formula representing the probability (existence probability) that an abnormal node exists in the nodes involved in executing the job, based on Nₜₒₜₐₗ and N_{abn}. Here, following formula (1) represents Nₜₒₜₐₗ.

Nₜₒₜₐₗ=N_{node}+Nₛₚₐᵣₑ (1)

In addition, the number of abnormal nodes in the job is represented by N_{abn}. For example, N_{abn} may be represented as following formula (2), using Nₜₒₜₐₗ and p_{abn}. Here, the binomial distribution with the number of trials n and the probability p is represented by B(n, p). In addition, ˜ means to follow the probability distribution.

N_{abn}˜B(Nₜₒₜₐₗ,p_{abn}) (2)

Then, the creation unit 502 may create the first model formula such as following formula (3), using above formulas (1) and (2). Here, the existence probability that an abnormal node exists in the nodes involved in executing the job is denoted by P[N_{abn}>0] (P[N_{abn}>0]∈[0, 1]). In following formula (3), the exponent part “Nₜₒₜₐₗ” represents “Nₜₒₜₐₗ”.

P[N_{abn}>0]=1−(1−p_{abn})Nₜₒₜₐₗ (3)

In addition, the creation unit 502 creates a second model formula representing the benchmark time involved in executing the benchmark in the job, based on P[N_{abn}>0], α_{abn}, and t_{bench}. The second model formula may be represented, for example, by following formulas (4) and (5).

Here, the benchmark time involved in executing the benchmark in the job is denoted by T_{bench}. The probability that T_{bench} has “T_{bench}=α_{abn}·t_{bench}” is represented by P[T_{bench}=α_{abn}·t_{bench}]. The probability that T_{bench} has “T_{bench}=t_{bench}” is represented by P[T_{bench}=t_{bench}]. When there is even one abnormal node, “T_{bench}=α_{abn}·t_{bench}” is met, otherwise “T_{bench}=t_{bench}” is met.

P[T_{bench}=α_{abn}·t_{bench}]=P[N_{abn}>0] (4)

P[T_{bench}=t_{bench}]=1−P[N_{abn}>0] (5)

In addition, based on N_{node}, Nₛₚₐᵣₑ, and p_{abn}, the creation unit 502 creates a third model formula representing the probability (exclusion probability) that the abnormal node may be excluded from the execution of the application. The third model formula may be represented, for example, by following formula (6). Here, the probability that the abnormal node may be excluded from the execution of the application is denoted by P[N_{abn}≤Nₛₚₐᵣₑ] (P[N_{abn}≤Nₛₚₐᵣₑ]∈[0, 1]). Nₜₒₜₐₗ is represented by above formula (1).

$$P [ {N}_{abn} \leq {N}_{spare} ] = {\sum }_{i = 0}^{{N}_{spare}} ( \begin{matrix}{N}_{total} \\ i\end{matrix} ) {( {p}_{abn} )}^{i} {( 1 - {p}_{abn} )}^{{N}_{total} - i} \qquad ( 6 )$$

In addition, the creation unit 502 creates a fourth model formula representing application time in the job, based on t_{cmpt}, t_{comm}, α_{abn}, and P[N_{abn} Nₛₚₐᵣₑ]. The application time is the execution time involved in executing the application. The fourth model formula may be represented, for example, by following formulas (7) and (8).

Here, the application time in the job is denoted by Tₐₚₚ (Tₐₚₚ>0). The probability that Tₐₚₚ has “Tₐₚₚ=α_{abn}·t_{cmpt}+t_{comm}” is represented by P[Tₐₚₚ=α_{abn}·t_{cmpt}+t_{comm}]. The probability that Tₐₚₚ has “Tₐₚₚ=t_{cmpt}+t_{comm}” is represented by P[Tₐₚₚ=t_{cmpt}+t_{comm}]. When the number of abnormal nodes exceeds the number of spare nodes, “Tₐₚₚ=α_{abn}·t_{cmpt}+t_{comm}” is met, otherwise “Tₐₚₚ=t_{cmpt}+t_{comm}” is met.

P[Tₐₚₚ=α_{abn}·t_{cmpt}+t_{comm}]=1−P[N_{abn}≤Nₛₚₐᵣₑ] (7)

P[Tₐₚₚ=t_{cmpt}+t_{comm}]=P[N_{abn}≤Nₛₚₐᵣₑ] (8)

In addition, the creation unit 502 creates a fifth model formula representing the expected value of the job time, based on the benchmark time in the job and the application time in the job. The job time is the execution time involved in executing the job. The job time is the time obtained by aggregating the benchmark time in the job and the application time in the job and is represented by following formula (9). Here, the job time is denoted by Tₜₒₜₐₗ.

Tₜₒₜₐₗ=T_{bench}+Tₐₚₚ (9)

For example, the creation unit 502 may create a fifth model formula such as following formula (10) from above formulas (4), (5), (7), (8), and (9). Here, the expected value of the job time is denoted by E[Tₜₒₜₐₗ] (>0). The expected value of the benchmark time in the job is denoted by E[T_{bench}]. The expected value of the application time in the job is denoted by E[Tₐₚₚ].

$$E [ {T}_{total} ] = E [ {T}_{bench} ] + E [ {T}_{app} ] = ( ( 1 - P [ {N}_{abn} > 0 ] ) + P [ {N}_{abn} > 0 ] {α}_{abn} ) {t}_{bench} + ( P [ {N}_{abn} \leq {N}_{spare} ] + ( 1 - P [ {N}_{abn} \leq {N}_{spare} ] ) {α}_{abn} ) {t}_{cmpt} + {t}_{comm} \qquad ( 10 )$$

Then, the creation unit 502 creates the performance model M based on the created fifth model formula and Nₜₒₜₐₗ. Nₜₒₜₐₗ is represented by above formula (1). The performance model M may be represented, for example, by following formula (11). Here, the expected value of the node time (cost) is denoted by E[C] (C>0).

E[C]=Nₜₒₜₐₗ·E[Tₜₒₜₐₗ] (11)

Note that the expected value of the node time when this approach is not used (corresponding to As-is to be described later) is equivalent to E[C] when “t_{bench}=0, Nₛₚₐᵣₑ=0” is assumed (because the benchmark is not executed and no spare node is used). In this case, T_{bench} has “T_{bench}=0” and Tₜₒₜₐₗ has “Tₜₒₜₐₗ=Tₐₚₚ”.

The determination unit 503 uses the created performance model M to determine Nₛₚₐᵣₑ (the number of spare nodes) that minimizes E[C]. For example, the determination unit 503 uses the performance model M to calculate E[C] while changing Nₛₚₐᵣₑ in order from zero to Nₙₒde. Then, the determination unit 503 may determine Nₛₚₐᵣₑ corresponding to the minimum value among calculated E[C], as Nₛₚₐᵣₑ that minimizes E[C].

In addition, the determination unit 503 may calculate E[C] while changing Nₛₚₐᵣₑ limited to only odd or even numbers among numbers from zero to N_{node}. The determination unit 503 also may calculate E[C] while changing Nₛₚₐᵣₑ from zero to N_{node} at intervals of predetermined numbers. The intervals of predetermined numbers may be set arbitrarily. This may enable to lower the amount of computation involved in determining Nₛₚₐᵣₑ.

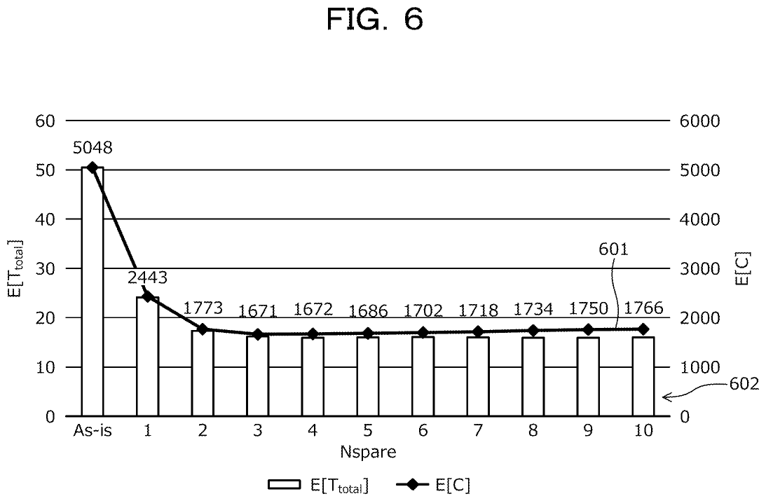

Here, an example of E[C] calculation will be described with reference to FIG. 6. Here, t_{cmpt}=10, t_{comm}=5, N_{node}=100, p_{abn}=0.005, α_{abn}=10, and t_{bench}=0.1 are assumed. It is also assumed that numerical computation is performed using the double-precision floating-point format.

FIG. 6 is a diagram illustrating an example of E[C] calculation. In FIG. 6, the line graph 601 illustrates changes in E[C] calculated by changing Nₛₚₐᵣₑ in order from one to ten. Here, in FIG. 6, the right vertical axis indicates E[C]. The horizontal axis indicates Nₛₚₐᵣₑ. In addition, As-is indicates E[C] when this approach is not used.

Furthermore, the bar graph 602 illustrates changes in E[Tₜₒₜₐₗ] calculated by changing Nₛₚₐᵣₑ in order from one to ten. Here, in FIG. 6, the left vertical axis indicates E[Tₜₒₜₐₗ]. The horizontal axis indicates Nₛₚₐᵣₑ. In addition, As-is indicates E[Tₜₒₜₐₗ] when this approach is not used.

The line graph 601 takes the minimum value “E[C]=1671” when “Nₛₚₐᵣₑ=3” is met. This minimum value is 0.33 times As-is, and it may be seen that the cost is reduced compared with when this approach is not applied. According to the line graph 601 and the bar graph 602, when Nₛₚₐᵣₑ is less than three, although the number of redundant nodes decreases, it may be seen that the abnormal nodes are not fully excluded, and E[Tₜₒₜₐₗ] (the expected value of the job time) rises.

In addition, when Nₛₚₐᵣₑ is four or greater, although E[Tₜₒₜₐₗ] continues to take the optimum value, it may be seen that the number of nodes rises, and E[C] (the expected value of the node time) gradually rises. In this case, the determination unit 503 determines “Nₛₚₐᵣₑ=3” as Nₛₚₐᵣₑ (the number of spare nodes) that minimizes E[C].

Returning to the description of FIG. 5, the submission unit 504 designates the determined Nₛₚₐᵣₑ (the number of spare nodes) to submit the job. For example, the submission unit 504 designates N_{node} (the number of nodes to be used by the application) and Nₛₚₐᵣₑ (the number of spare nodes) to submit the job to the management node 202 illustrated in FIG. 2.

As a result, for example, the job is submitted into a queue in the management node 202. Then, for example, by the job scheduler P2 as illustrated in FIG. 9, which will be described later, the management node 202 takes out the job from the queue and allocates the job to the group of available nodes among the nodes N1 to Nn. The group of nodes is a group containing a number of nodes equal to the sum of N_{node} (the number of nodes to be used by the application) and Nₛₚₐᵣₑ (the number of spare nodes).

Note that the functional units of the login node 201 described above (such as the reception unit 501 to the submission unit 504) may be implemented by the management node 202 or the node Ni. In addition, the login node 201 may have the function of the management node 202 (such as the job scheduler P2) and the function of the node Ni (such as the job script P3). For example, when the login node 201 has the function of the management node 202, the submission unit 504 may allocate the job to the group containing a number of nodes equal to the sum (Nₜₒₜₐₗ) of the determined Nₛₚₐᵣₑ and N_{node}.

(Supplementation for Performance Model M)

Here, the supplementary explanation of the performance model M will be given.

In the above description, the designated parameters may include t_{cmpt} and t_{comm}, but there are cases where one or both of t_{cmpt} and t_{comm} are not known prior to executing the job. There are also cases where the execution time of the application is known, but the ratio between t_{cmpt} and t_{comm} is not known.

Therefore, the user is not sometimes unable to designate t_{cmpt} and t_{comm} as parameters. In this case, for example, the creation unit 502 may treat a constant multiple of the maximum usage time (wall-time) of the job or the execution time of the application as t_{cmpt}. The constant is a value less than one. In addition, the creation unit 502 may treat t_{comm} as zero, for example.

This is because, in an average parallel computing application, computation becomes rate-limiting under conditions where the computational performance has been degraded significantly, and “α_{abn}·t_{cmpt}>>t_{comm}” is expected. Note that the execution time of the application may be included in, for example, the submission request for the job, or may be stored in association with the application at the system side. The maximum usage time (wall-time) of the job is included in the submission request for the job, for example.

In addition, the user may calculate p_{abn} and α_{abn}, for example, from statistical information published by the system side, or may estimate p_{abn} and α_{abn} from the results obtained by executing a suitable benchmark job on the job scheduling system 200.

In addition, commonly, the fault rate of the node follows the course of a so-called failure rate curve (bathtub curve). For this reason, the fault intervals and the abnormality intervals of the node exhibit a probabilistic behavior. However, since the present embodiment focuses on “the probability that an abnormality has occurred at the moment a certain node is allocated to a job”, expressing this with a single value “p_{abn}” will not impair the versatileness.

For example, as in formulas (12) and (13) below, fault intervals t_{flt} (the intervals at which such an event that is detected and recovered by the system occurs) and abnormality intervals t_{abn} (the intervals at which an event that is the cause of performance degradation but is not detected by the system occurs) of each node are supposed to follow exponential distribution. Here, λ_{abn}<λ_{flt} is assumed.

t_{flt}˜Exp(λ_{flt}) (12)

t_{abn}˜Exp(λ_{abn}) (13)

Under this supposition, probability p_{abn_exp} that an abnormality has occurred when a certain node is reserved is represented by following formula (14). Here, the density function and the distribution function of exponential distribution Exp(λ) are indicated by f(x|λ) and F(x|λ), respectively.

$${p}_{abn \_ exp} = {\int }_{t = 0}^{∞} f ( t \vert {λ}_{flt} ) ( 1 - F ( t \vert {λ}_{abn} ) ) dt = {λ}_{flt} {\int }_{t = 0}^{∞} exp ( - ( {λ}_{flt} + {λ}_{abn} ) t ) dt = {λ}_{flt} / ( {λ}_{flt} + {λ}_{abn} ) \qquad ( 14 )$$

When “λA_{flt→}∞” is true, “(the uptime of the node)_{→}∞” is met, and since an abnormality has definitely occurred, “p_{abn_exp→}1” is met. In addition, when “λ_{abn→}∞” is true, “p_{abn_exp→}0” is met because no abnormality occurs. Similarly, p_{abn} may be expressed as a single value if the distribution of the fault intervals and the abnormality intervals is invariant and comparable for each node with respect to the overall system uptime.

Note that cases where the distribution of the fault intervals and the abnormality intervals is not comparable for each node are conceivable, such as cases where there is such a node that has an exceptionally great number of faults and abnormalities. In such cases, in a system such as the job scheduling system 200 in which many nodes with the same configuration are included, it is expected that the cause will be removed by, for example, replacing parts when recovering. Therefore, it is commonly expected that such an event will not occur.

(Functional Configuration Example of Node Ni)

Next, a functional configuration example of the node Ni will be described. The node Ni is one of the nodes (computing nodes) N1 to Nn.

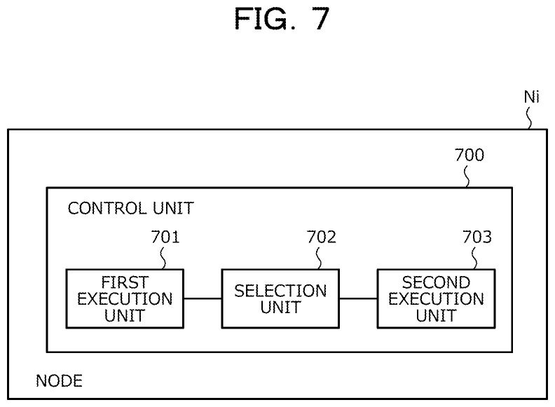

FIG. 7 is a diagram illustrating a functional configuration example of the node Ni. In FIG. 7, the node Ni includes a first execution unit 701, a selection unit 702, and a second execution unit 703. The first execution unit 701 to the second execution unit 703 have functions to form a control unit 700, and for example, these functions are implemented by causing the CPU 401 to execute a program (the job script P3 as illustrated in FIG. 9 to be described later) stored in a storage device such as the memory 402, the disk 404, or the portable recording medium 407 of the node Ni illustrated in FIG. 4, or by the communication I/F 405. The processing result of each functional unit is stored in, for example, a storage device such as the memory 402 or the disk 404 of the node Ni.

In response to the result of allocating a job to the group containing a number of nodes equal to Nₜₒₜₐₗ, the first execution unit 701 causes each node in the group of nodes to execute the benchmark. For example, a number obtained by summing up Nₛₚₐᵣₑ determined by the login node 201 and N_{node} designated by the user is denoted by Nₜₒₜₐₗ.

The benchmark is software (such as UNPACK) for evaluating the performance of the node, which is executed prior to the application within the job. For example, the first execution unit 701 uses the mpirun command attached to various MPI libraries to request each node in the group of nodes (including its own node) to execute the benchmark.

In the following description, a group of nodes to which a job is allocated will be sometimes referred to as a “group of nodes N[1] to N[m]” (m is a natural number equal to or greater than two).

In addition, the first execution unit 701 collects benchmark execution time of each node in the group of nodes N[1] to N[m]. The benchmark execution time is the time that is involved to execute the benchmark in the node. For example, the first execution unit 701 collects the benchmark execution times of each node in the group of nodes N[1] to N[m] from the standard output of mpirun. Here, the contents of the benchmark are adjusted such that the time for each node is output to the standard output of mpirun.

In addition, the benchmark logs for each node may be output to an independent path on the file system FS illustrated in FIG. 2. In this case, for example, the first execution unit 701 may collect the benchmark execution time of each node in the group of nodes N[1] to N[m] from the file system FS.

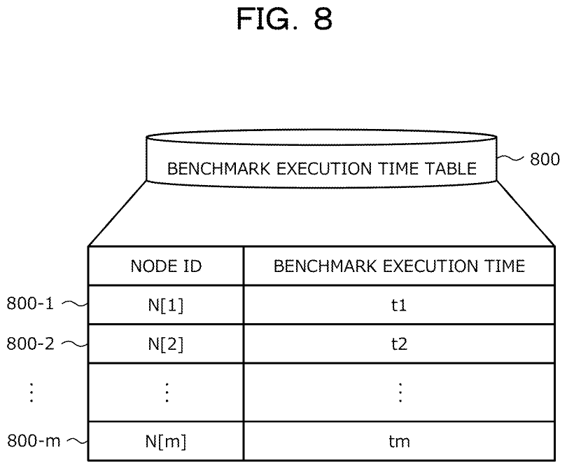

The collected benchmark execution time is stored, for example, in a benchmark execution time table 800 as illustrated in FIG. 8. The benchmark execution time table 800 is implemented by a storage device such as the memory 402 or the disk 404 of the node Ni, for example.

FIG. 8 is a diagram illustrating an example of the stored contents of the benchmark execution time table 800. In FIG. 8, the benchmark execution time table 800 has fields of node ID and benchmark execution time and, by setting information in each field, stores benchmark execution time information 800-1 to 800-m as records.

Here, the node ID contains the identifier that uniquely identifies a node included in the group of nodes N[1] to N[m]. The benchmark execution time contains the benchmark execution time of the node identified by the node ID. For example, the benchmark execution time information 800-1 indicates the benchmark time of the node N[1] in the group of nodes.

The selection unit 702 selects a node that is to execute the application related to the execution of the job, based on the collected benchmark execution time and N_{node}. For example, the selection unit 702 refers to the benchmark execution time table 800 illustrated in FIG. 8 to select a number of nodes equal to N_{node} in order from the shortest benchmark execution time, from the group of nodes N[1] to N[m].

The second execution unit 703 causes the selected nodes to execute the application. For example, the second execution unit 703 creates a host file enumerating the host names, with the node ID of each of the selected nodes, of which the number is equal to N_{node}, as the host name. Then, the second execution unit 703 designates the N_{node} lines on the created host file by arguments when the application is executed.

This allows the second execution unit 703 to cause the nodes, of which the number is equal to N_{node}, selected from the group of nodes N[1] to N[m] to execute the job.

Note that the functional units of the node Ni described above (such as the first execution unit 701 to the second execution unit 703) may be implemented by the login node 201 or the management node 202. In addition, the node Ni may have the function of the login node 201 (such as the submission script P1) and the function of the management node 202 (such as the job scheduler P2).

(Operation Example of Job Scheduling System)

Next, an operation example of the job scheduling system 200 will be described.

FIG. 9 is a diagram illustrating an operation example of the job scheduling system 200. In FIG. 9, the login node 201, the management node 202, the node N1 among the nodes N1 to Nn, and the file system FS in the job scheduling system 200 are illustrated. Here, a case where the node N1 executes the job script P3 is assumed.

First, the login node 201 receives designation of parameters 900 from a user U by the submission script P1. The user U is a user who operates the submission script P1 to request the execution of a job and corresponds to the client terminal 203 illustrated in FIG. 2. The parameters 900 include N_{node}, t_{cmpt}, t_{comm}, t_{bench}, p_{abn}, and α_{abn}.

Then, by the submission script P1, the login node 201 creates the performance model M based on the designation of the parameters 900. Next, by the submission script P1, the login node 201 determines Nₛₚₐᵣₑ that minimizes E[C], using the performance model M. Then, by the submission script P1, the login node 201 designates N_{node} and Nₛₚₐᵣₑ to submit the job to the management node 202.

The management node 202 allocates the submitted job to the group of available nodes among the nodes N1 to Nn by the job scheduler P2 and executes the job script P3. A path for accessing the main body of the job script P3 in the file system FS is designated by the submission script P1, for example. In addition, all the information contained in the job script P3 is passed from the submission script P1 by way of the job scheduler P2, for example.

Note that information for scheduling, such as lists of jobs and nodes, is held by the job scheduler P2, for example. In addition, any existing technique may be used for the process of identifying the group of available nodes from among the nodes N1 to Nn. For example, the job scheduler P2 may identify a node to which no job is allocated, or identify a node with a sufficient CPU usage rate or the like.

By the job script P3, the node N1 creates a node list 901 of nodes to be used for application execution, by causing each node in the group of nodes to which the job is allocated, to execute the benchmark. Then, by the job script P3, the node N1 selects a number of nodes equal to N_{node}, using the node list 901 to execute the application. Information involved in executing the application or the benchmark (such as the paths to executables and arguments of the application and the benchmark) is passed to the job script P3 from the submission script P1 by way of the job scheduler P2, for example.

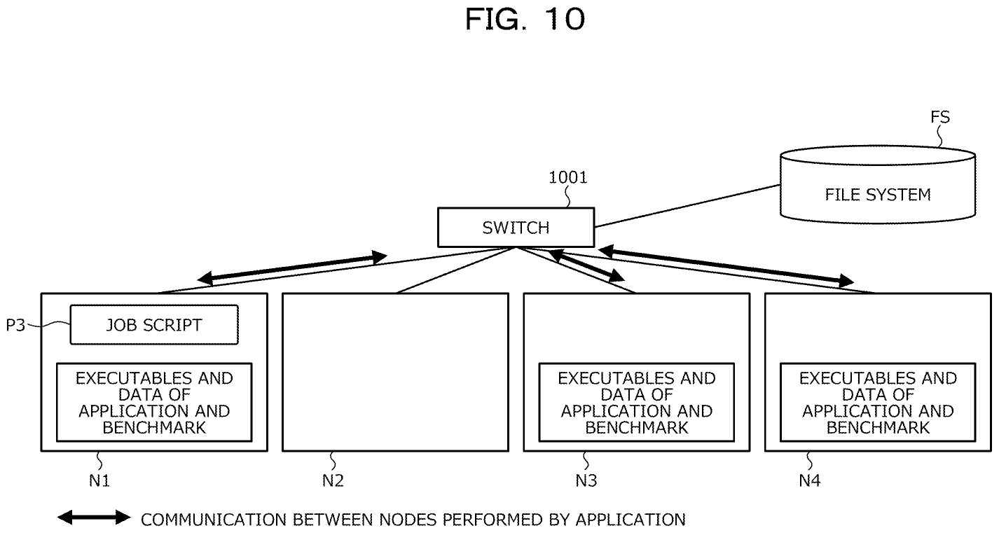

Here, an example of coupling between nodes that execute the application will be described with reference to FIG. 10.

FIG. 10 is a diagram illustrating an example of coupling between nodes. In FIG. 10, nodes N1, N2, N3, and N4 are an example of the group of nodes N[1] to N[m] reserved to execute a job. The nodes N1, N3, and N4 are examples of a number of nodes equal to N_{node}, which have been selected as nodes that are to execute the application.

The node N1 requests the nodes N1, N3, and N4 to execute the application by the job script P3. The application execution request to each of the nodes N1, N3, and N4 is implemented, for example, by commands (mpiexec or mpirun) implemented by the MPI library.

In addition, communication between nodes performed by the application is performed via, for example, a switch 1001 (in FIG. 10, a tree structure with the switch 1001 is assumed). This enables high-performance communication even between nodes in non-consecutive physical locations in the job scheduling system 200.

(Job Execution Example)

Next, an example of job execution will be described with reference to FIG. 11.

FIG. 11 is a diagram illustrating a job execution example. The login node 201 creates the performance model M based on the designation of parameters (N_{node}, t_{cmpt}, t_{comm}, p_{abn}, α_{abn}, and t_{bench}). The login node 201 uses the performance model M to determine Nₛₚₐᵣₑ that minimizes E[C]. Here, a case where N_{node} has “N_{node}=3” and Nₛₚₐᵣₑ is determined as “Nₛₚₐᵣₑ=1” is assumed. In this case, the management node 202 allocates the job to four nodes, which is the sum of Nₛₚₐᵣₑ and N_{node}.

In FIG. 11, nodes 1101 to 1104 are nodes included in the nodes N1 to Nn and are an example of the group of nodes N[1] to N[m] reserved to execute the job. Here, the node 1101 is assumed to be the node Ni that executes the job script P3 (refer to FIG. 9, for example).

In FIG. 11, “bench” indicates the benchmark execution time of each of the nodes 1101 to 1104. In addition, “collection” refers to the time involved in collecting the benchmark execution time of each of the nodes 1101 to 1104. Here, the time involved in collecting the benchmark execution time is supposed to be negligibly small. In addition, “computation” indicates the computation time for the application. The total computation time for the entire application corresponds to t_{cmpt}. “Communication” indicates the communication time between nodes in the application. The total communication time for the entire application corresponds to t_{comm}.

The node 1101 causes each of the nodes 1101 to 1104 to execute the benchmark. The node 1101 then collects the benchmark execution time of each of the nodes 1101 to 1104. Here, an abnormality has occurred in the node 1103, and the benchmark execution time of the node 1103 is longer than the benchmark execution time of the nodes 1101, 1102, and 1104.

Based on “N_{node}=3”, the node 1101 selects the nodes 1101, 1102, and 1104 relevant to the three shortest of the benchmark time, as nodes that are to execute the application. Here, since the number of abnormal nodes “1” is equal to or smaller than Nₛₚₐᵣₑ, the node 1103 may be excluded as an abnormal node.

Then, the node 1101 causes the selected nodes 1101, 1102, and 1104 to execute the application. This allows the node 1101 to restrain the computational performance from degrading because of the execution of the application related to the execution of the job on the abnormal node. The node time has (the number of nodes: 4)×(the usage time: Tx) (corresponding to the area of the dotted line frame 1110 in FIG. 11).

(Job Submission Processing Procedure of Login Node)

Next, a job submission processing procedure of the login node 201 will be described. The job submission process corresponds to, for example, a part of a job scheduling process.

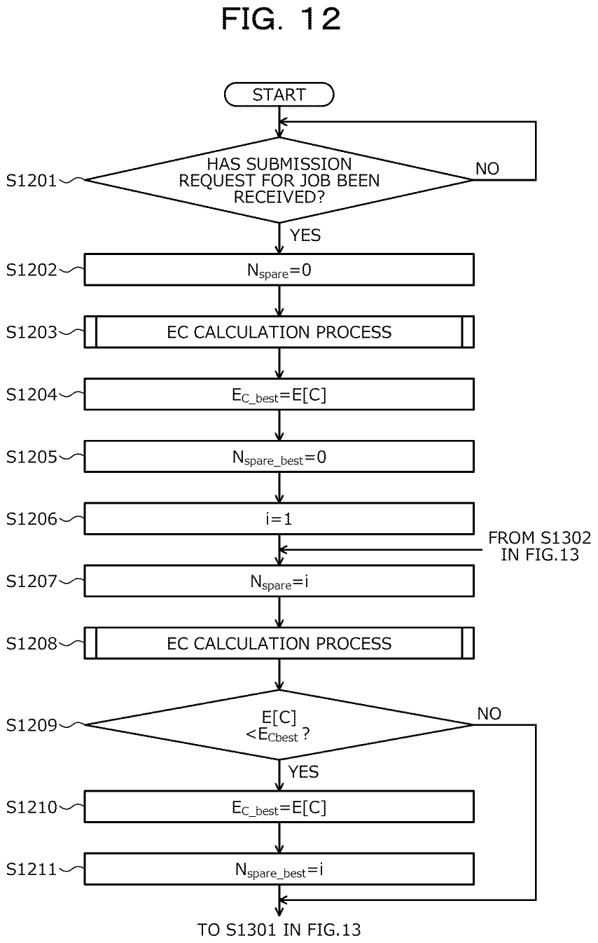

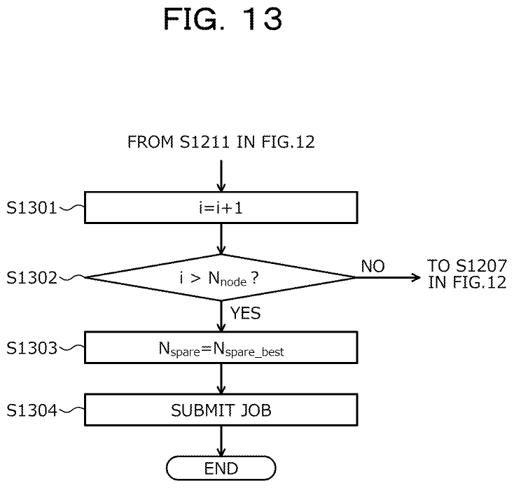

FIGS. 12 and 13 are flowcharts illustrating an example of the job submission processing procedure of the login node 201. In the flowchart in FIG. 12, first, the login node 201 verifies whether or not the submission request for a job has been received from the client terminal 203 (step S1201).

The submission request for the job includes information such as designation of parameters (N_{node}, t_{cmpt}, t_{comm}, p_{abn}, α_{abn}, and t_{bench}), the computation contents of the job, and the maximum usage time (wall-time), for example. Here, the login node 201 waits for receiving the submission request for a job (step S1201: No).

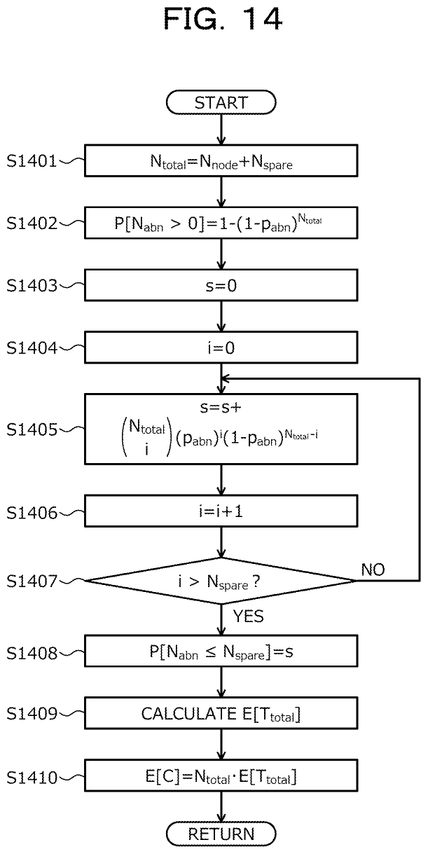

When receiving the submission request for a job (step S1201: Yes), the login node 201 sets Nₛₚₐᵣₑ as “Nₛₚₐᵣₑ=0” (step S1202) and executes an EC calculation process for calculating E[C] (step S1203). A specific processing procedure of the EC calculation process will be described later with reference to FIG. 14.

Then, the login node 201 sets E_{C_best} to E[C] calculated in step S1203 (step S1204) and sets N_{spare_best} as “N_{spare_best}=0” (step S1205). Next, the login node 201 sets i as “i=1” (step S1206).

Then, the login node 201 sets Nₛₚₐᵣₑ as “Nₛₚₐᵣₑ=i” (step S1207) and executes the EC calculation process based on the designation of parameters included in the submission request for the job (step S1208). A specific processing procedure of the EC calculation process will be described later with reference to FIG. 14.

Next, the login node 201 verifies whether or not E[C] calculated in step S1208 is smaller than E_{C_best} (step S1209). Here, when E[C] is smaller than E_{C_best} (step S1209: Yes), the login node 201 sets E_{C_best} to E[C] calculated in step S1208 (step S1210).

The login node 201 then sets N_{spare_best} as “N_{spare_best}=i” (step S1211) and proceeds to step S1301 illustrated in FIG. 13. In addition, in step S1209, when E[C] is equal to or greater than E_{C_best} (step S1209: No), the login node 201 proceeds to step S1301 illustrated in FIG. 13.

In the flowchart in FIG. 13, first, the login node 201 increments i (step S1301) and verifies whether or not i is greater than N_{node} (step S1302). Here, when i is equal to or smaller than N_{node} (step S1302: No), the login node 201 proceeds to step S1207.

On the other hand, when i is greater than N_{node} (step S1302: Yes), the login node 201 sets Nₛₚₐᵣₑ as “Nₛₚₐᵣₑ=N_{spare_best}” (step S1303). Then, the login node 201 designates Nₛₚₐᵣₑ to submit the job (step S1304) and ends the series of processes according to this flowchart.

This allows the login node 201 to designate the number of spare nodes that minimizes the expected value of the node time (cost) and submit a job.

Next, a specific processing procedure of the EC calculation process in steps S1203 and S1208 illustrated in FIG. 12 will be described.

FIG. 14 is a flowchart illustrating an example of a specific processing procedure of the EC calculation process. In the flowchart in FIG. 14, first, the login node 201 creates above formula (1) based on N_{node} and Nₛₚₐᵣₑ (step S1401). Then, the login node 201 creates above formula (3) from above formulas (1) and (2), based on Nₜₒₜₐₗ and N_{abn} (step S1402).

Next, the login node 201 sets s as “s=0” (step S1403) and sets i as “i=0” (step S1404). Then, the login node 201 calculates s from following formula (15), based on Nₜₒₜₐₗ and p_{abn} (step S1405). Following formula (15) corresponds to above formula (6).

$$s = s + ( \begin{matrix}{N}_{total} \\ i\end{matrix} ) {( {p}_{abn} )}^{i} {( 1 - {p}_{abn} )}^{{N}_{total} - i} \qquad ( 15 )$$

Next, the login node 201 increments i (step S1406) and verifies whether or not i is greater than Nₛₚₐᵣₑ (step S1407). Here, when i is equal to or smaller than Nₛₚₐᵣₑ (step S1407: No), the login node 201 returns to step S1405.

On the other hand, when i is greater than Nₛₚₐᵣₑ (step S1407: Yes), the login node 201 sets P[N_{abn}≤Nₛₚₐᵣₑ] as “P[N_{abn}≤Nₛₚₐᵣₑ]=s” (step S1408). Next, the login node 201 calculates E[Tₜₒₜₐₗ] using above formula (10) (step S1409).

For example, the login node 201 creates above formulas (4) and (5) based on P[N_{abn}>0], α_{abn}, and t_{bench}. In addition, the login node 201 creates above formulas (7) and (8) based on t_{cmpt}, t_{comm}, α_{abn}, and P[N_{abn}≤Nₛₚₐᵣₑ]. Then, the login node 201 creates above formula (10) from above formulas (4), (5), (7), (8), and (9) and calculates E[Tₜₒₜₐₗ].

The login node 201 then uses calculated E[Tₜₒₜₐₗ] to calculate E[C] from above formula (11) (step S1410) and returns to the step that called the EC calculation process.

This allows the login node 201 to calculate the expected value of the node time (cost).

(Job Execution Control Processing Procedure of Node Ni)

Next, a job execution control processing procedure of the node Ni will be described. The node Ni is a node having the job script P3 in the group of nodes N[1] to N[m]. The job execution control process corresponds to, for example, a part of the job scheduling process.

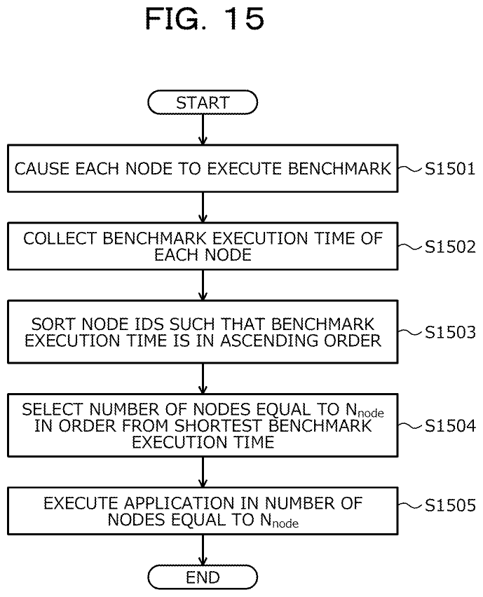

FIG. 15 is a flowchart illustrating an example of the job execution control processing procedure of the node Ni. In the flowchart in FIG. 15, first, the node Ni causes each node in the group of nodes N[1] to N[m] to which the job is allocated, to execute the benchmark (step S1501).

Next, the node Ni collects the benchmark execution time of each node (step S1502). Then, the node Ni sorts each of the node IDs of the group of nodes N[1] to N[m] such that the collected benchmark execution time of each node is in ascending order (step S1503).

Next, the node Ni refers to the sorted node IDs to select a number of nodes equal to N_{node} in order from the shortest benchmark execution time (step S1504). Then, the node Ni executes the application in the selected nodes, of which the number is equal to N_{node}, (step S1505) and ends the series of processes according to this flowchart.

This allows the node Ni to suppress degradation of the computational performance for the application due to the allocation of the abnormal node to the user and to restrict the increase in the node time.

(E[C] Reduction Example)

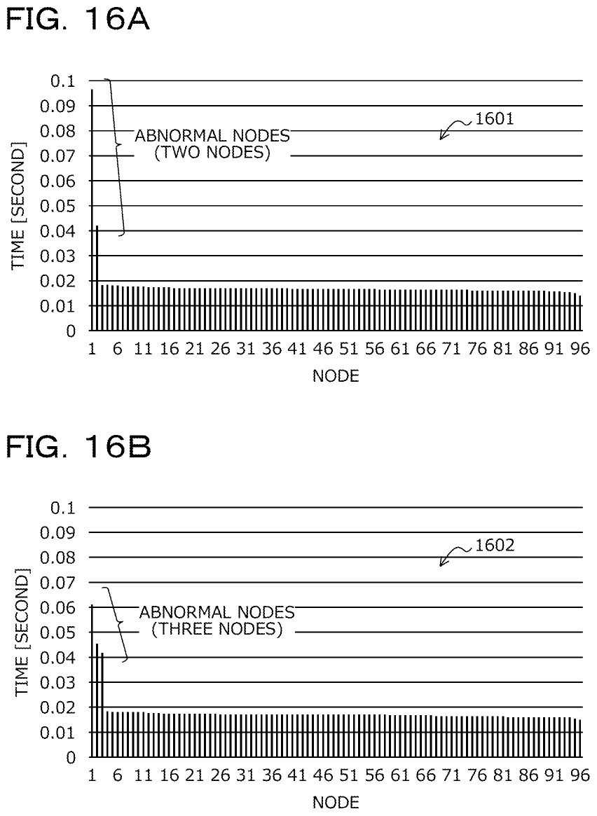

Next, an example of reduction of E[C] when this approach is applied will be described. First, an example of calculation of p_{abn}, α_{abn}, and t_{bench} designated as parameters will be described with reference to FIGS. 16A and 16B.

FIGS. 16A and 16B are diagrams illustrating a specific example of the benchmark time of each node. In FIG. 16A, the bar graph 1601 (bar graph with 96 bars) represents the benchmark time of each node sorted in descending order when a job A is executed by 96 nodes among the nodes N1 to Nn. According to the bar graph 1601, the top two nodes may be said to be abnormal nodes.

In FIG. 16B, the bar graph 1602 (bar graph with 96 bars) represents the benchmark time of each node sorted in descending order when a job B is executed by 96 nodes among the nodes N1 to Nn. According to the bar graph 1602, the top three nodes may be said to be abnormal nodes.

For example, t_{bench} may be calculated from an average value of the benchmark time of the non-abnormal nodes. Here, t_{bench} has “t_{bench}=0.0167 [s]”. In addition, for example, α_{abn} may be calculated from the ratio between the respective average values of the benchmark time of the abnormal nodes and the non-abnormal nodes. Here, α_{abn} has “α_{abn}=3.53”. In addition, p_{abn} may be calculated by maximum likelihood estimation, for example. Here, p_{abn} has “p_{abn}={(2+3)/2}/96=0.026”.

Next, an example of prediction of E[C] will be described. Here, a case where the expected value (E[C]) of the node time is predicted from above formula (11) with N_{node}=100 for three cases with different computational loads “(t_{cmpt}, t_{comm})=(100 seconds, 0 seconds), (50 seconds, 50 seconds), (10 seconds, 90 seconds)” will be described as an example.

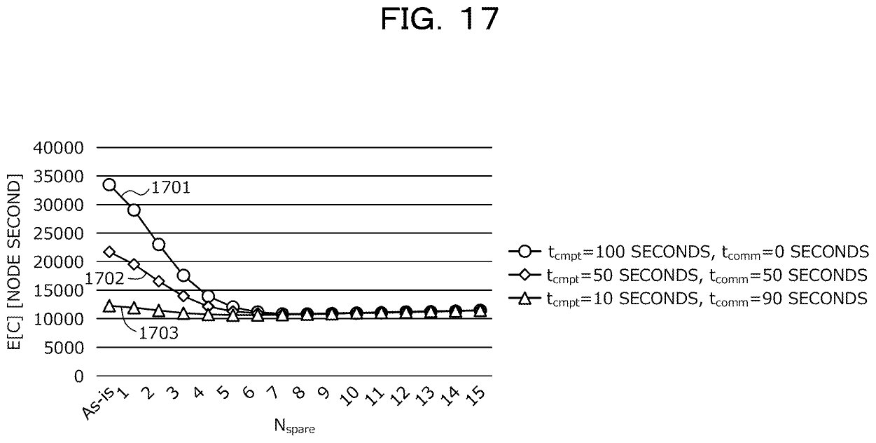

FIG. 17 is a diagram illustrating an example of prediction of E[C]. In FIG. 17, the line graph 1701 illustrates changes in E[C] when Nₛₚₐᵣₑ is changed in order from 1 to 15 with “(t_{cmpt}, t_{co}mm)=(100 seconds, 0 seconds)”. Here, in FIG. 17, the vertical axis indicates E[C]. The horizontal axis indicates Nₛₚₐᵣₑ. In addition, As-is indicates E[C] when this approach is not used.

The line graph 1702 illustrates changes in E[C] when Nₛₚₐᵣₑ is changed in order from 1 to 15 with “(t_{cmpt}, t_{comm})=(50 seconds, 50 seconds)”. The line graph 1703 illustrates changes in E[C] when Nₛₚₐᵣₑ is changed in order from 1 to 15 with “(t_{cmpt}, t_{comm})=(10 seconds, 90 seconds)”.

In the line graph 1701, E[C] is the smallest when Nₛₚₐᵣₑ has “Nₛₚₐᵣₑ=8”, and it is estimated that E[C] may be reduced to about (1/3.1) times E[C] of As-is. Note that the optimum value “Nₛₚₐᵣₑ=8” means that, if 108 nodes are reserved and eight nodes are exempted, almost all abnormal nodes may be excluded and the expected value of the node time takes the minimum value.

In the line graph 1702, E[C] is the smallest when Nₛₚₐᵣₑ has “Nₛₚₐᵣₑ=7”, and it is estimated that E[C] may be reduced to about (½) times E[C] of As-is. In the line graph 1703, E[C] is the smallest when Nₛₚₐᵣₑ has “Nₛₚₐᵣₑ=5”, and it is estimated that E[C] may be reduced to about (1/1.2) times E[C] of As-is.

Note that, in the above explanation, the case where the benchmark is executed in the job submitted by the user has been described as an example, but the execution of the benchmark is not limited to this. For example, operations from executing the benchmark to exempting an abnormal node may be performed at the manager side of the job scheduling system 200.

In this case, for example, when many nodes are allocated to one job, operations from executing the benchmark to exempting an abnormal node are performed at the manager side (for example, the management node 202) prior to the execution of the user's application. Then, by handing over the list of nodes from which abnormal nodes have been excluded, from the manager side to the user's application, it is expected that performance degradation of the application may be moderated and node utilization efficiency may be improved.

In addition, when the above operations are performed at the manager side (for example, the management node 202), for example, the management node 202 may detect an abnormal node using a certain index when collecting the benchmark execution time of each node. For example, when many abnormal nodes are detected, the management node 202 may exempt the abnormal nodes from the job scheduling system 200. When it is difficult to exempt the abnormal node, a mechanism intended to protect the user from being disadvantaged may be provided by, for example, notifying the user from the manager side. In addition, for example, the management node 202 may calculate parameters that are invariant to the application (such as p_{abn}, α_{abn}, and t_{bench}) among the parameters of the performance model M, from the benchmark execution time of each node.

In addition, for supercomputers that adopt mesh or torus-type topologies, where the physical node locations have a relatively strong impact on the communication performance, if the abnormal node is exempted at the user side, the locations become inconsecutive, and there is a possibility that communication latency between particular nodes will increase. However, when system-level exemption of the abnormal node as described above is applied to a supercomputer having a high-dimensional mesh topology, a group of nodes consecutive on a network may be provided to the user side, for example, by an approach similar to usual exemption of defective nodes.

As described above, according to the login node 201 of the job scheduling system 200 according to the embodiment, designation of parameters may be received when a job is to be executed. The parameters include, for example, N_{node}, p_{abn}, α_{abn}, and t_{bench}. In addition, according to the login node 201, the performance model M that outputs E[C] from E[Tₜₒₜₐₗ] and Nₜₒₜₐₗ may be created based on the received designation of the parameters. Then, according to the login node 201, Nₛₚₐre (the number of spare nodes) that minimizes E[C] may be determined using the created performance model M.

This allows the login node 201 to search for and locate the number of spare nodes that minimizes the expected value of the node time (cost) when submitting a job with a redundant number of nodes in consideration of the occurrence of an abnormal node and to determine the number of nodes to efficiently execute the job. For example, the login node 201 may designate the number of spare nodes that minimizes the expected value of the node time (cost) to submit a job.

In addition, according to the login node 201, designation of parameters including the first processing time and the second processing time may be received. The first processing time is processing time that is affected by performance degradation due to the abnormal node, within the execution time of the application. The second processing time is processing time that is not affected by performance degradation due to the abnormal node, within the execution time of the application.

This allows the login node 201 to create the performance model M in consideration of, as the execution time of the application, the processing time that is affected by performance degradation due to the abnormal node and the processing time that is not affected by performance degradation due to the abnormal node. Therefore, the login node 201 may accurately predict E[C] in consideration of the characteristics of the application.

In addition, according to the login node 201, designation of parameters including t_{cmpt} and t_{comm} may be received. An example of the first processing time is given by t_{cmpt}. An example of the second processing time is given by t_{comm}.

This allows the login node 201 to arbitrarily designate the computation time of each node in the application and the communication time between nodes in the application, as parameters defined depending on the application, when all nodes cooperate to perform computation of the application executed within the job. Therefore, the login node 201 may create the performance model M that considers the characteristics of the application and may improve the prediction accuracy for E[C].

In addition, according to the login node 201, the first model formula representing the existence probability (P[N_{abn}>0]) that an abnormal node exists in the nodes involved in executing the job may be created based on N_{node}, Nₛₚₐᵣₑ, and p_{abn}, and the second model formula representing the benchmark time (P[T_{bench}=α_{abn}·t_{bench}], P[T_{bench}=t_{bench}]) in the job may be created based on the first model formula, α_{abn}, and t_{bench}.

This allows the login node 201 to predict the benchmark time in the job, in consideration of the existence probability that an abnormal node exists in the nodes involved in executing the job.

In addition, according to the login node 201, the third model formula representing the exclusion probability (P[N_{abn}≤Nₛₚₐᵣₑ]) that the abnormal node may be excluded from the execution of the application may be created based on N_{node}, Nₛₚₐᵣₑ, and p_{abn}. Then, according to the login node 201, the fourth model formula representing the application time (P[Tₐₚₚ=α_{abn}·t_{cmpt}+t_{comm}], P[Tₐₚₚ=t_{cmpt}+t_{comm}]) in the job may be created based on t_{cmpt}, t_{comm}, α_{abn}, and the third model formula.

This allows the login node 201 to predict the application time in the job, in consideration of the exclusion probability that the abnormal node may be excluded from the execution of the application.

In addition, according to the login node 201, the fifth model formula representing the expected value of the job time (E[Tₜₒₜₐₗ]) may be created based on the second model formula and the fourth model formula, and the performance model M may be created based on the fifth model formula, N_{node}, and Nₛₚₐᵣₑ.

This allows the login node 201 to accurately predict the expected value of the job time and to improve the prediction accuracy for the node time.

In addition, according to the node Ni of the job scheduling system 200 according to the embodiment, each node in the group of nodes may be caused to execute the benchmark, in response to the result of allocating the job to the group of nodes N[1] to N[m], of which the number is equal to Nₜₒₜₐₗ. For example, a number obtained by summing up Nₛₚₐᵣₑ determined by the login node 201 and N_{node} designated by the user is denoted by Nₜₒₜₐₗ. Then, according to the node Ni, a number of nodes equal to N_{node} selected in order from the shortest benchmark execution time from the group of nodes N[1] to N[m] may be caused to execute the application.

This allows the node Ni to cause the application to be executed by excluding a node that takes a long time to execute the benchmark, from the group of nodes N[1] to N[m]. Consequently, the node Ni may suppress degradation of the computational performance for the application due to the allocation of the abnormal node to the user and restrict the increase in the node time.

For these reasons, according to the job scheduling system 200 according to the embodiment, the minimum number of nodes that may restrict the increase in the node time without modifying the job or hardware environment may be determined even when the abnormal node is exempted, and the job may be executed efficiently.

Note that the scheduling method described in the present embodiment may be implemented by executing a program prepared in advance on a computer such as a personal computer or a workstation. The present scheduler is recorded on a computer-readable recording medium such as a hard disk, a flexible disk, a CD-ROM, a DVD, or a USB memory and is read from the recording medium to be executed by the computer. In addition, this scheduler may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
when a job is executed by one or more nodes in a system, receiving designation of a number of nodes to be used by an application related to execution of the job, abnormality occurrence probability of the one or more nodes in the system, a ratio of processing time of an abnormal node to processing time of a normal node in the system, and benchmark time involved in executing a benchmark that is executed in the job prior to the application;
creating a performance model that outputs an expected value of resource consumption amount involved in executing the job, from an expected value of execution time involved in executing the job, the number of nodes to be used, and a first number of spare nodes for the job, based on the received designation; and
determining a second number of the spare nodes that minimizes the expected value of the resource consumption amount using the created performance model.

2. The non-transitory computer-readable recording medium according to claim 1, wherein
the designation includes designation of first processing time that is affected by performance degradation due to the abnormal node and second processing time that is not affected by the performance degradation due to the abnormal node, within execution time involved in executing the application.

3. The non-transitory computer-readable recording medium according to claim 2, wherein
the first processing time is computation time involved in computation of each of the nodes in the execution of the application, and
the second processing time is communication time involved in communication between the nodes in the execution of the application.

4. The non-transitory computer-readable recording medium according to claim 1, the process further comprising:
in response to a result of allocating the job to a group of nodes, of which the number is equal to a sum of the determined number of the spare nodes and the number of the nodes to be used, causing each node in the group of the nodes to execute the benchmark; and
causing nodes, of which a number is equal to the number of the nodes to be used and which are selected in order from a shortest processing time involved in executing the benchmark from the group of the nodes, to execute the application.

5. The non-transitory computer-readable recording medium according to claim 2, the process further comprising:
creating a first model formula that represents existence probability that the abnormal node exists in nodes involved in executing the job, based on the number of the nodes to be used, the first number of the spare nodes, and the abnormality occurrence probability;
creating a second model formula that represents the benchmark time in the job, based on the first model formula, the ratio, and the benchmark time;
creating a third model formula that represents exclusion probability that it is feasible to exclude the abnormal node from execution of the application, based on the number of the nodes to be used, the first number of the spare nodes, and the abnormality occurrence probability;
creating a fourth model formula that represents application time in the job, based on the first processing time, the second processing time, the ratio, and the third model formula;
creating a fifth model formula that represents the expected value of the execution time involved in executing the job, based on the second model formula and the fourth model formula; and
creating the performance model, based on the created fifth model formula, the number of the nodes to be used, and the first number of the spare nodes.

6. A job scheduling method, comprising:
when a job is executed by one or more nodes in a system, receiving by a computer, designation of a number of nodes to be used by an application related to execution of the job, abnormality occurrence probability of the one or more nodes in the system, a ratio of processing time of an abnormal node to processing time of a normal node in the system, and benchmark time involved in executing a benchmark that is executed in the job prior to the application;
creating a performance model that outputs an expected value of resource consumption amount involved in executing the job, from an expected value of execution time involved in executing the job, the number of nodes to be used, and a first number of spare nodes for the job, based on the received designation; and
determining a second number of the spare nodes that minimizes the expected value of the resource consumption amount using the created performance model.

7. An information processing device, comprising:
a memory; and
a processor coupled to the memory and the processor configured to:
when a job is executed by one or more nodes in a system, receive designation of a number of nodes to be used by an application related to execution of the job, abnormality occurrence probability of the one or more nodes in the system, a ratio of processing time of an abnormal node to processing time of a normal node in the system, and benchmark time involved in executing a benchmark that is executed in the job prior to the application;
create a performance model that outputs an expected value of resource consumption amount involved in executing the job, from an expected value of execution time involved in executing the job, the number of nodes to be used, and a first number of spare nodes for the job, based on the received designation; and
determine a second number of the spare nodes that minimizes the expected value of the resource consumption amount using the created performance model.
